(19) United States
(12) Patent Application Publication
(10) Pub. No.: US 2016/0068111 A1
(43) Pub. Date: Mar. 10, 2016

(54) BIKE CARRIER

(71) Applicant: Cequent Performance Products, Inc., Plymouth, MI (US)

(72) Inventors: Mark Andrew Walker, Royal Oak, MI (US); Austin Jon Laurer, Canton, MI (US)

(21) Appl. No.: 14/847,443

(22) Filed: Sep. 8, 2015

Related U.S. Application Data
(60) Provisional application No. 62/046,614, filed on Sep. 5, 2014.

(51) Int. Cl. B60R 9/10; B60R 9/06

(52) U.S. Cl. CPC B60R 9/10; B60R 9/06

(57) ABSTRACT

The present disclosure includes a bike carrier having a longitudinal rail section with first and second wheel supporting members for supporting the wheels of a loaded bicycle. A retaining arm may be pivotally arranged relative to the longitudinal rail section. A telescoping rail may be configured to extend and retract relative to the longitudinal rail section. The bike carrier may include a hitch attachment member having a folding mechanism that is configured to tilt the bike carrier from an in-use position to a storage position. The bike carrier may be configured to support additional bike carriers in a generally scalable arrangement such that a plurality of bike carriers can extend from the hinge mechanism and tilt from the in-use position into the storage position.

### CROSS-REFERENCE TO RELATED APPLICATIONS

This application claims the benefit of U.S. Provisional Patent Application No. 62/046,614 entitled “BIKE CARRIER” filed on Sep. 5, 2014, which is hereby incorporated by reference in its entirety.

### TECHNICAL FIELD

The present invention relates to a bicycle carrier and more particularly, to hitch mounted type bike carrier that is scalable and adjustable.

### BACKGROUND

Bicycle carrier equipment may include various configurations of rail members, arms, and fasteners designed to assist a user to stabilize a bicycle on a vehicle for storage or transport. Conventional bicycle carrier equipment can be roof mounted, trunk mounted or hitch mounted to the vehicle. These carriers include various fastening systems to secure the bike to the carrier and various fastening systems to secure the carrier to the vehicle.

A disadvantage of these bike carriers, however, is that they are generally bulky and take up a lot of space either on the roof or rear portion of the vehicle. Additionally, hitch mounted bike carriers for multiple bikes take up a large relative amount of space that is undesirable for the user when the carriers are not being utilized to transport or store bicycles.

Hitch mounted bike carriers that extend from the rear of a vehicle, however, often result in making the vehicle more difficult to park, maneuver, and the like. This may result in the bikes and bike carriers needing to either be moved or removed from the vehicle in order to park or effectively maneuver the vehicle. This, however, can be time consuming and may require the bike carrier to be stored, which may not be feasible and is not likely preferred.

Current bike carriers often are limited by the size of the bike which can be operatively attached with such bike carrier. If the bike does not fit, these bike carriers typically provide no adjustability. Known bike carriers may also suffer from a large number of disadvantages which make it inconvenient for a user to transport or store at least one bike thereon. For example, current bike carriers can only carry a predetermined number of bikes. They do not have the ability to expand or reduce the number of bikes that are operatively attachable thereto. If a user wishes to carry three bikes, the user may need to have a bike carrier that can carry at least three bikes, such as a four bike carrier. This may require a user to purchase a bike carrier that exceeds his or her needs or may require a user to purchase a plurality of bike carriers to meet the needs of carrying a different number of bikes.

Therefore, there is a need for a bike carrier that is capable of transporting or storing multiple bikes that is easy to configure in a more compact position during non-use and to expand and/or retract the capability thereof. In view thereof, there exists a need for a bike carrier of such design that it affords a solution which overcomes the disadvantages of previously known bike carriers.

### SUMMARY

The present disclosure includes a bike carrier having a longitudinal rail section with a wheel supporting member positioned near a first end and a wheel cradle positioned at an opposite second end for supporting the wheels of a loaded bicycle. A retaining arm is pivotally arranged relative to the longitudinal rail section and is provided with a hook member that is telescopingly attached to the retaining arm. The retaining arm is arranged so that it can be rotated into a support position in which the hook member can be extended or retracted into a position abutted against the frame or the wheel of the loaded bicycle when the loaded bicycle is in an upright position along the bike carrier.

The wheel cradle includes a telescoping rail that is configured to be extended and retracted relative to the longitudinal rail section. A first cradle member has a generally U-shaped cross section and is attached to the telescoping rail and configured to receive a portion of the wheel of the loaded bicycle. A second cradle member has a generally U-shaped cross section and is attached to the longitudinal rail section and configured to receive a portion of the wheel of the loaded bicycle. The first cradle member is longitudinally adjustable by extending and retracting the telescoping rail relative to longitudinal rail. This movement adjusts a positioned the first and second cradle members to abut against opposite portions of the wheel of the loaded bicycle. The wheel cradle and hook member support the loaded bicycle in an upright position.

Additionally, the bike carrier may attach to a hitch receiver, which is attached to an associated vehicle. The hitch receiver often attaches to the frame of the vehicle and may extend immediately below the bumper of the vehicle from the rear thereof. The bike carrier may be attached to a folding mechanism that includes a draw bar that can be selectively attached to the hitch receiver and secured to the vehicle. The folding mechanism is configured to tilt the bike carrier from an in-use position to a storage position.

In another embodiment, the folding mechanism can include a support arm that is configured to support additional bike carriers in a generally scalable arrangement such that a plurality of bike carriers can extend from the hinge mechanism and tilt from the in-use position into the storage position.

In one embodiment, provided is a bike carrier configured to be attached to a vehicle. The bike carrier may include a first rail having a first wheel supporting member positioned at a first end, a second rail, the first and second rails telescopingly engaged, the second rail having a second wheel supporting member positioned at a second end, and a hitch attachment member. The hitch attachment member may be configured to be scalable and support at least one additional rail member such that the additional rail member may extend from the hitch attachment member and be configured to support a bike. A retaining arm may be pivotally arranged relative to the longitudinal rail section and includes a hook member that is telescopingly attached to the retaining arm. The retaining arm may be configured to pivot between a support position and release position and the hook member may be configured to be extended or retracted into a position abutted against the bike when the bike is supported by the bike carrier.

The second wheel supporting member may include a wheel cradle having a first cradle member attached to the telescoping rail and a second cradle member attached to the longitudinal rail. The first cradle member may include a generally U-shaped cross section and may be configured to receive a portion of the wheel of the bike and the second cradle member may have a generally U-shaped cross section and may be configured to receive a portion of the wheel of the bike. The first cradle member may be longitudinally adjustable relative to the second cradle member by extending and retracting the telescoping rail relative to longitudinal rail. The hitch attachment member may include a folding mechanism, the folding mechanism may include a draw bar configured to be selectively attached to the hitch receiver and secured to the vehicle wherein the folding mechanism may be configured to tilt the bike carrier from an in-use position to a storage position. The folding mechanism may include a support arm that is configured to support additional rail members in a generally scalable arrangement such that a plurality of bike carriers or rail members can extend from the hitch attachment member and tilt from the in-use position into the storage position. The second rail member or bike carrier may include a support arm configured to be attached to the hitch attachment member.

A third bike carrier or rail member may include a support arm configured to be attached to the support arm of the second bike carrier. At least one of the first wheel supporting member and the second wheel supporting member may be an attachment member that includes a strap configured to selectively attach and tighten the wheel to the attachment member. The attachment member may include a body portion that defines a cavity configured to be received along the telescoping rail. The attachment member may include a top portion having a surface for supporting a wheel of the bike such that the surface may define a groove and includes a slot such that the strap may extend through the slot and be configured to be positioned within the groove along the surface as the wheel is positioned on the surface. The attachment member may include a second slot. The surface of the attachment member may include a plurality of teeth to provide a frictional engagement with the wheel of the bike. The attachment member may include at least one alignment peg that extends from the body. The peg may be configured to vertically stabilize the wheel along the attachment member.

In another embodiment, disclosed is a scalable bike carrier system configured to be attached to a vehicle. The scalable bike carrier system may include a first bike carrier including a hitch attachment member configured to attach the first bike carrier to the vehicle. A second bike carrier may include a support member, the support member may be configured to be selectively attached to the first bike carrier. A third bike carrier may include a support member, the support member may be configured to be selectively attached to the second bike carrier. The first bike carrier may further include a longitudinal rail with a first wheel supporting member positioned near a first end and a telescoping rail configured to be extended and retracted relative to the longitudinal rail. The telescoping rail may include a second wheel supporting member positioned at an opposite second. The support member of the second bike carrier may be configured to selectively attach to the hitch attachment member. The hitch attachment member may include a folding mechanism configured to pivot from the in-use position into the storage position.

The scalable bike carrier system may further include a retaining arm that is pivotally attached to the first bike carrier and a retaining arm that is pivotally attached to the second bike carrier. The retaining arm of the first bike carrier may include a hook wherein the retaining arm and hook may be configured to be adjusted to directly support either a bike frame or a bike wheel on the first bike carrier. Further, the retaining arm of the second bike carrier may include a hook wherein the retaining arm and hook may be configured to be adjusted to directly support either a bike frame or a bike wheel on the second bike carrier.

In one embodiment, provided is a bike carrier configured to be attached to a vehicle. The bike carrier may include a first rail having a first wheel supporting member positioned at a first end and a second rail having a second wheel supporting member positioned at a second end. The first and second rails may be telescopingly engaged. The bike carrier may include a hitch attachment member wherein at least one of the first wheel supporting member and the second wheel supporting member is an attachment member that includes a strap configured to selectively attach and tighten the wheel to the attachment member.

### DESCRIPTION OF THE DRAWINGS

FIG. 1 is a perspective view of one embodiment of the bike carrier of the present disclosure supporting an exemplary bike in an upright position thereon;

FIG. 2 is a top view of the bike carrier of FIG. 1 of the present disclosure;

FIG. 3 is a front view of the bike carrier of FIG. 1 of the present disclosure;

FIG. 4 is a side view of the bike carrier of FIG. 1 of the present disclosure;

FIG. 5 is a top view of the bike carrier of FIG. 1 of the present disclosure;

FIG. 6 is a side view of the bike carrier of FIG. 1 of the present disclosure;

FIG. 7 is a front view of the bike carrier of FIG. 1 of the present disclosure;

FIG. 8 is a perspective view of embodiments of a first bike carrier and a second bike carrier of the present disclosure;

FIG. 9 is a top view of the first and second bike carriers of FIG. 8 of the present disclosure;

FIG. 10 is a side view of the first and second bike carriers of FIG. 8 of the present disclosure;

FIG. 11 is a perspective view of embodiments of the bike carriers of the present disclosure;

FIG. 12 is a top view of the bike carriers of FIG. 11 of the present disclosure;

FIG. 13 is a front view of the bike carriers of FIG. 11 of the present disclosure;

FIG. 14 is a perspective view of the bike carrier of the present disclosure arranged in a storage position;

FIG. 15 is a top view of the bike carrier arranged in the storage position of FIG. 14 of the present disclosure;

FIG. 16 is a side view of the bike carrier arranged in the storage position of FIG. 14 of the present disclosure;

FIG. 17 is a front view of the bike carrier arranged in the storage position of FIG. 14 of the present disclosure;

FIG. 18 is a perspective view of an attachment member of the present disclosure;

FIG. 19 is a perspective view of an embodiment of the bike carrier in a use position with the attachment member of FIG. 18; and

FIG. 20 is a side view of embodiment of the bike carrier with the attachment member of FIG. 18.

### DETAILED DESCRIPTION

Reference will now be made in detail to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment.

The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

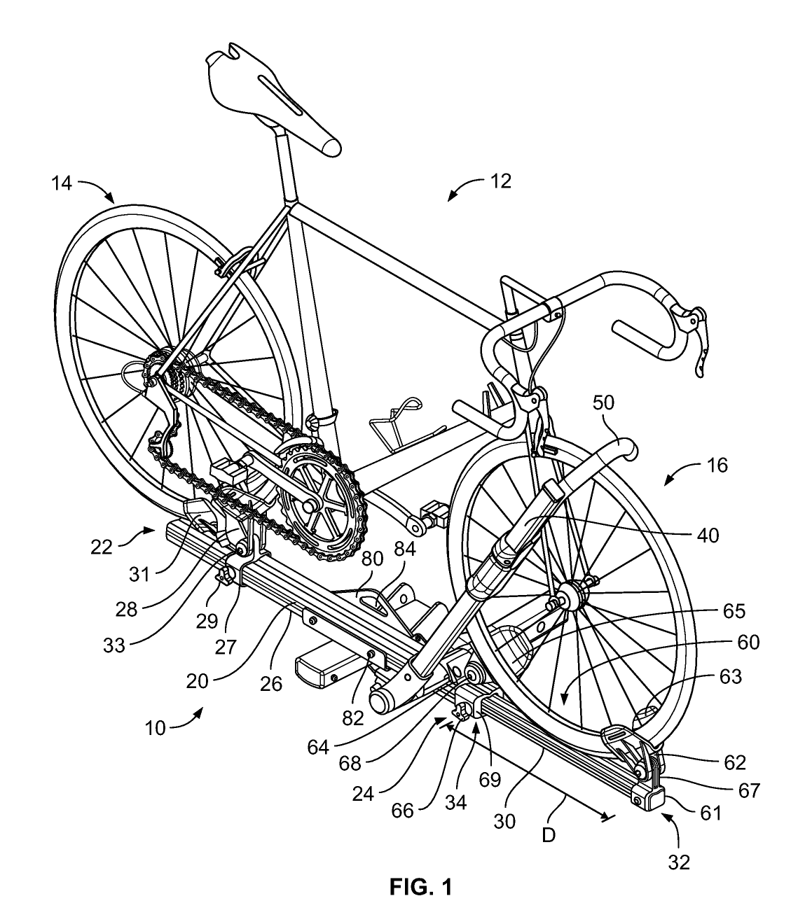

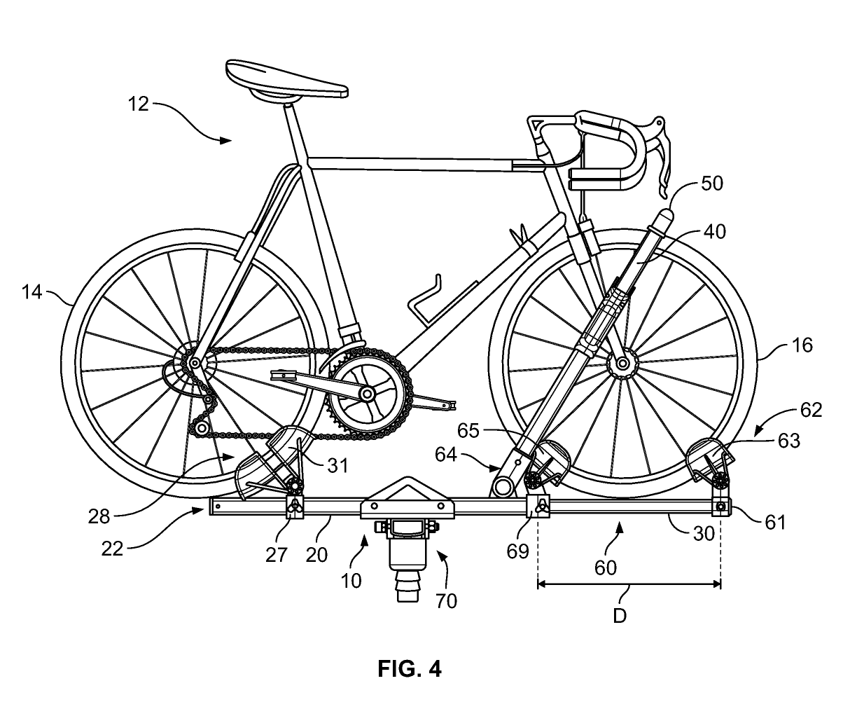

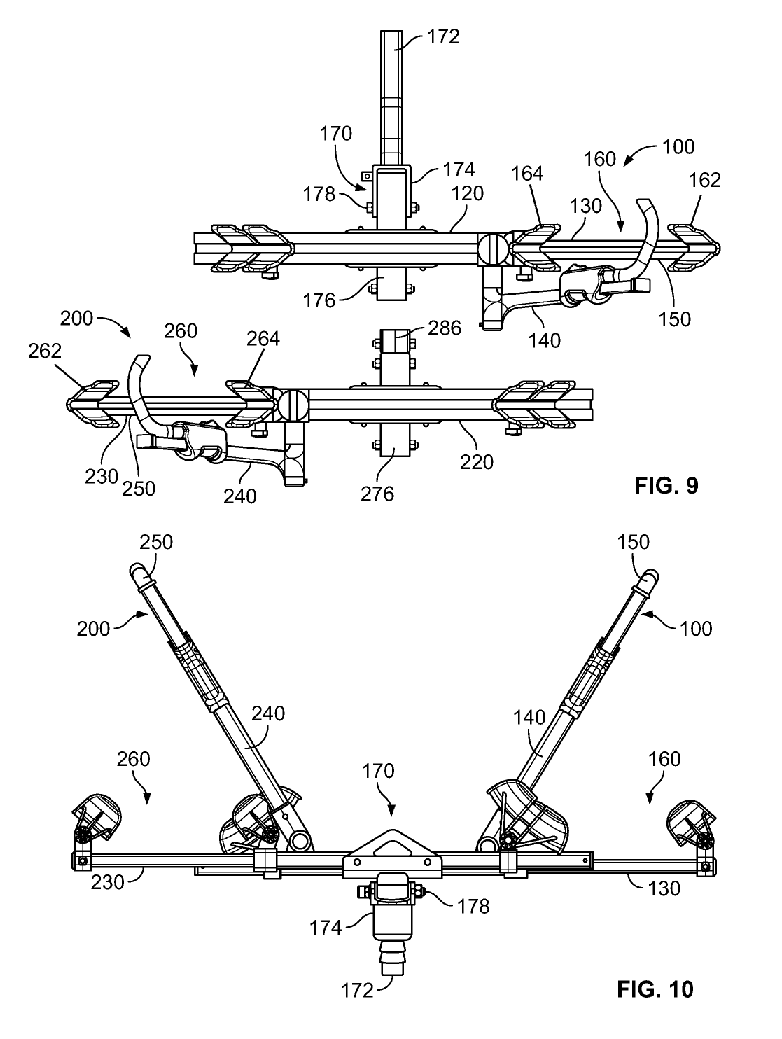

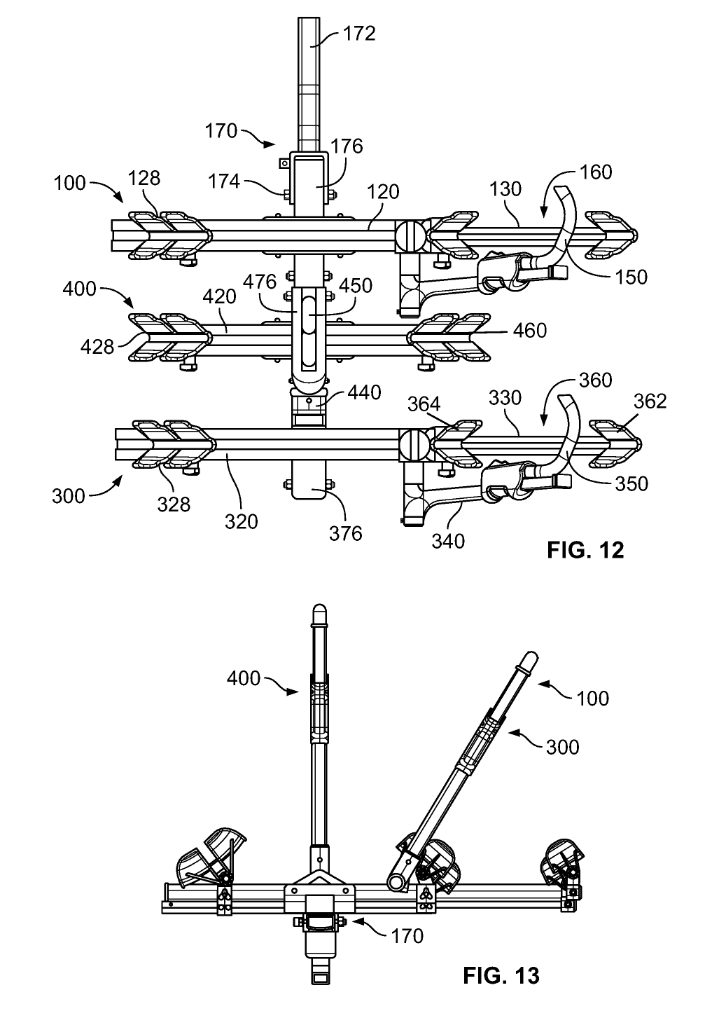

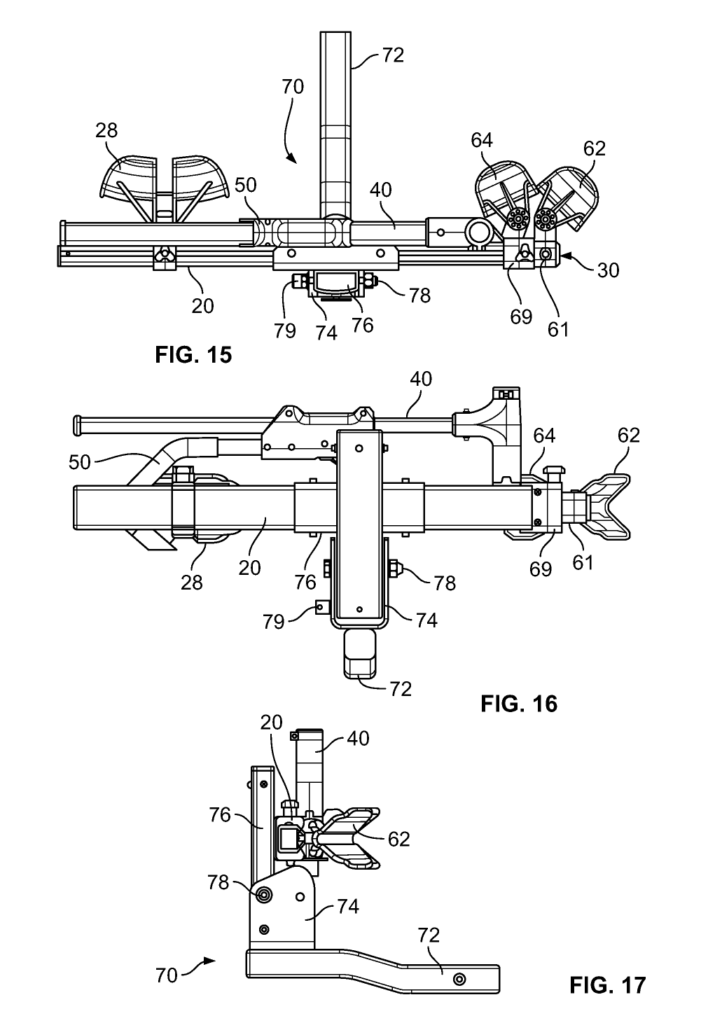

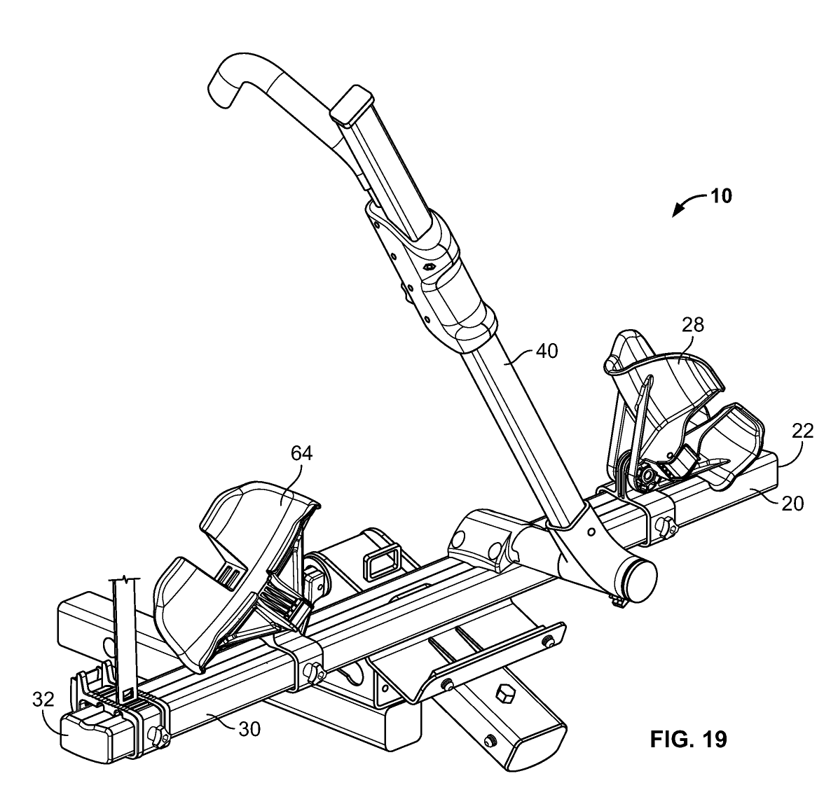

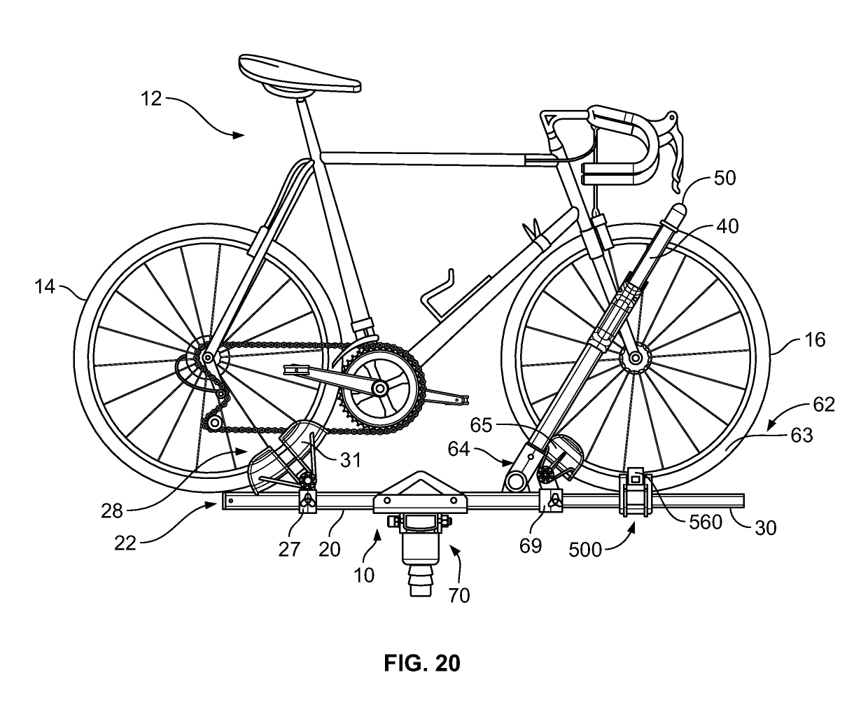

When relational terms such as “upper,” “lower,” “horizontal,” “vertical,” “top,” “bottom,” “side,” etc. are used herein, reference is made to various embodiments of a bike carrier of the present disclosure when oriented as shown, for example, in FIGS. 1-20, it being understood that such terms are used in their relative senses and are not intended to be limiting in scope or meaning

FIGS. 1-4 illustrates a bike carrier 10 that may include an adjustable and scalable configuration adapted to support a bike 12 thereon. The bike carrier 10 may be capable of selectively attaching to a vehicle (not shown) in any appropriate manner. The bike 12 that may be attached to the bike carrier 10 may be of any known or future developed configuration. As a means of an example, the bike 12 shown includes a rear or first wheel 14 and an opposite front or second wheel 16.

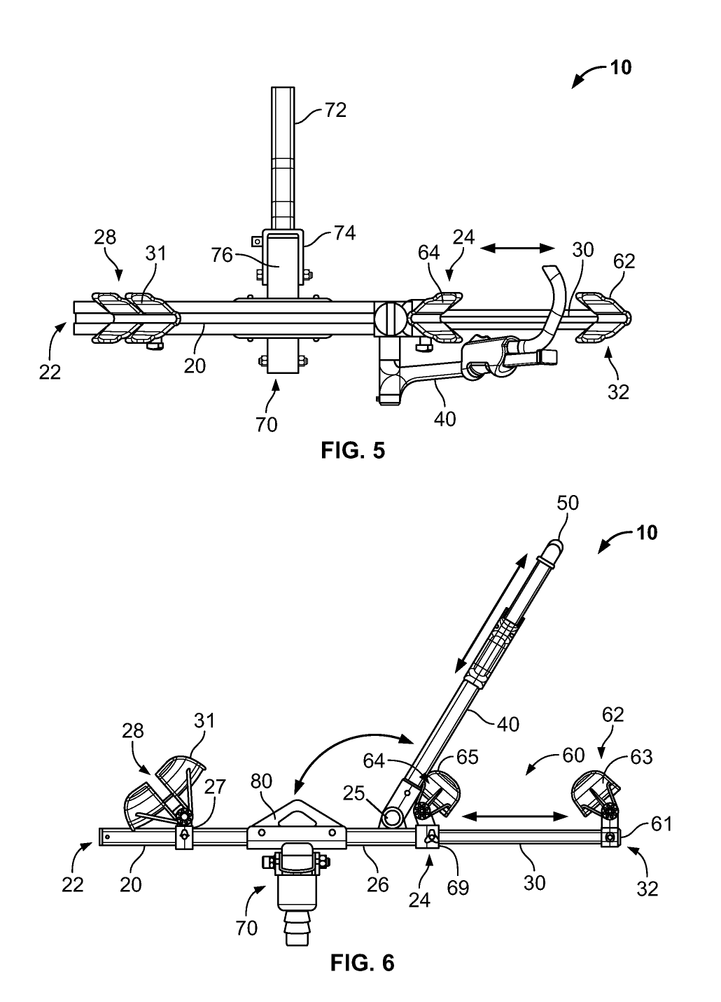

As illustrated by FIGS. 5-7, the bike carrier 10 may include a longitudinal rail 20 having attached thereto a telescoping rail 30. The longitudinal rail 20 may include a first end 22 and an opposite second end 24. A wheel supporting member 28 may be attached to the longitudinal rail 20 adjacent the first end 22 in any appropriate manner.

By way of a non-limiting example, the wheel supporting member 28 may be attached utilizing fasteners, being snap-fitted, friction fitted, welded or adhered to the longitudinal rail 10 or may be monolithically formed with the longitudinal rail 20 or a combination thereof. The wheel supporting member 28 may have a base 31. The base 31 may have a generally U-shaped cross sectional configuration for receiving and supporting a portion of the first wheel 14. Additionally, the wheel supporting member 28 may be longitudinally adjustable relative to the longitudinal rail 20 and rotatably adjustable relative to the longitudinal rail 20. The wheel supporting member 28 may be longitudinally adjustable relative to a first cradle member 62 and a second cradle member 64. In one embodiment, the wheel supporting member 28 may include a bracket 27 and fastener 29. The bracket 27 may be configured to slide along the longitudinal rail 20 and the fastener 29 may be ergonomically configured for a user to manually tighten or loosen the bracket 27 relative to the longitudinal rail 20. Additionally, the base 31 may be rotatably adjustable relative to the bracket 27 and may also include a fastener 33 configured to tighten and loosen the base 31 relative to the bracket 27.

The telescoping rail 30 may extend from the second end 24 of the longitudinal rail 20 and may be adapted to selectively extend and retract therefrom. The telescoping rail 30 may include a distal end 32 and a proximal end 34, the proximal end 34 may extend from the second end 24 of the longitudinal rail 20. It should be understood, however, that the telescoping rail 30 may also extend from the first end 22 of the longitudinal rail 24.

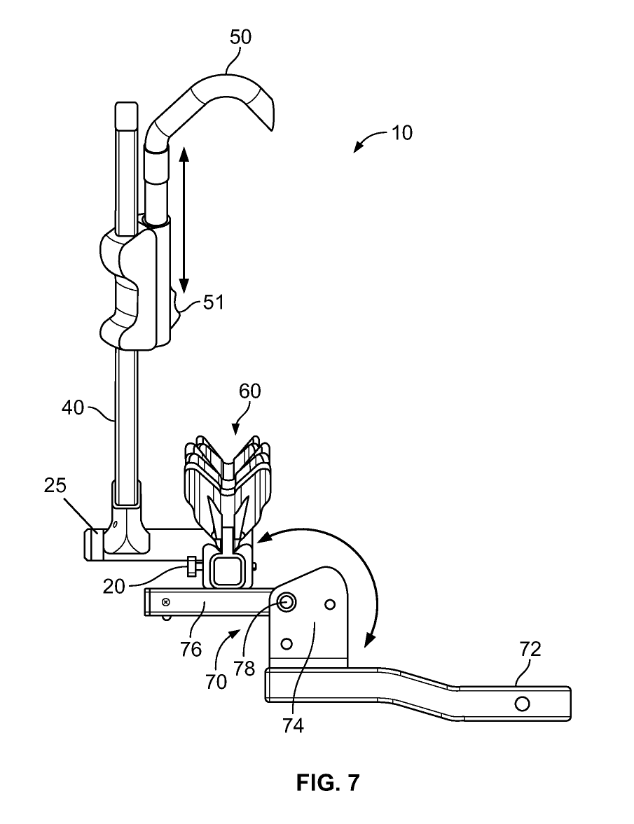

A retaining arm 40 may be pivotally arranged relative to the longitudinal rail section 20 or the telescoping rail 30 and provided with a hook member 50. The hook member 50 may be telescopingly attached to the retaining arm 40. The retaining arm 40 may be arranged so it rotates relative to the longitudinal rail 20 and/or telescoping rail 30. The retaining arm 40 may be attached to the rail 20 at a pivot base 25 positioned along the longitudinal rail 20 between the second cradle member 64 and a hitch attachment member 70. The pivot base 25 may be attached to a top side of the longitudinal rail 20 but can also be attached to a bottom side. The hook member 50 may be arranged so it extends or retracts relative to the retaining arm 40. Additionally, the hook member may include a toggle member 51 (FIG. 7) that may selectively lock the hook member 50 in a position along the retaining arm 40.

In one embodiment, a portion of the longitudinal rail 20 and the telescoping rail 30 may form a wheel cradle 60. The wheel cradle 60 may include the telescoping rail 30 configured to extend and retract relative to the longitudinal rail 20. The telescoping rail 30 may be insertable into the longitudinal rail 20. Alternatively, the longitudinal rail 20 may be insertable into the telescoping rail 20. As illustrated for example in FIG. 6, the first cradle member 62 may include a first bracket 61 and a first base 63. The first bracket 61 may be attached to the distal end 32 of the telescoping rail 30. The first base 63 may be attached to the first bracket 61 and may have a generally U-shaped cross sectional shape—although the present teachings are not limited to this specific configuration. The first base 63 may be of any appropriate cross-sectional shape, including without limitation a C-shape, V-shape, etc. The first cradle member 62 may be configured to receive a portion of a wheel of a loaded bicycle 12, such as the second wheel 16.

The second cradle member 64 may include a second bracket 69 and a second base 65. The second bracket 69 may be attached to the longitudinal rail 20. In some embodiments, the second bracket 69 may be attached to the telescoping rail 30. Alternatively, the second bracket 69 may be attached to the second end 24 of the longitudinal rail 30.

The second base 65 may have a generally U-shaped cross sectional shape and may be attached to the second bracket 69. The second base 65 may be of any appropriate cross-sectional shape, including without limitation a C-shape, V-shape, etc. The second cradle member 64 may be configured to receive a portion of the wheel of the loaded bicycle 12, such as the second wheel 16. Additionally, the second cradle member 64 may be longitudinally adjustable relative to the longitudinal rail 20 or the telescoping rail 30. In some embodiments, the second bracket 69 may include a fastener 66. The bracket 69 may be configured to slide along the longitudinal rail 20 or the telescoping rail 30 and the fastener 66 may be ergonomically configured for a user to manually tighten or loosen the bracket 69 thereon. Additionally, the first base 63 and the second base 65 may be rotatably adjustable relative to first bracket 61 and the second bracket 69, respectively. The first and second brackets 61, 69 may also includes a fastener 67, 68 configured to tighten and loosen the first base 63 and second base 65 relative to the first bracket 61 and second bracket 69, respectively. The first bracket 61 and second bracket 69 are also adjustable relative to one another.

The wheel cradle 60 may be longitudinally adjustable relative to the size of the bike wheel by extending and retracting the telescoping rail 30 relative to longitudinal rail 20. This movement may adjust a position of the first and second cradle members 62, 64 to abut against opposite portions of the second wheel 16 of the loaded bicycle 12. In some embodiments, the second bracket 69 may be attached to the second end 24 of the longitudinal rail 20 and the fastener 66 may be configured to toggle the adjusted position of the telescoping rail 30. The fastener 66 may be ergonomically configured to allow the user to easily toggle the fastener 66 in a tightened or loosened orientation relative to the telescoping rail 30, longitudinal rail 20 and the second bracket 69. Still further in some embodiments, the second cradle member 64 may be fixed relative to the longitudinal rail 20.

The wheel cradle 60 and hook member 50 on the retaining arm 40 may support the loaded bicycle 12 in an upright position on the bike carrier 10. Extending and/or retracting the telescoping rail 30 may adjust the width of the wheel cradle 60. By way of a non-limiting example, extending and/or retracing the telescoping rail 30 may adjust a distance D between the first and second cradle members 62, 64.

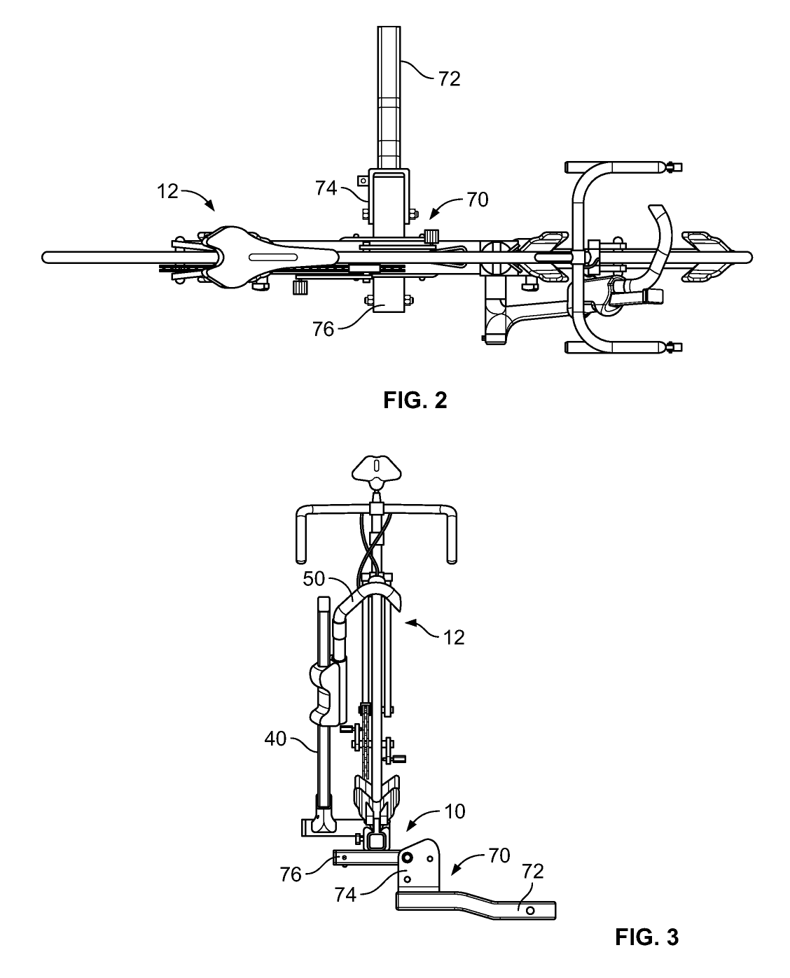

By way of a non-limiting example, the bike carrier 10 may be attached to a conventional hitch receiver attached to a rear portion of a vehicle (not shown). In this embodiment, as clearly identified by FIGS. 2, 3 and 7, the bike carrier 10 may include a hitch attachment member 70 configured to support at least one additional bike carrier such that an additional bike carrier may extend from the hitch attachment member. The hitch attachment member 70 may be a folding mechanism that includes a draw bar 72 capable of selectively attaching to the hitch receiver of the vehicle at the rear portion of the vehicle. The hitch attachment member 70 may be configured to attached to any sized vehicle hitch such as class I, II, III, or IV. The bike carrier 10 may, therefore, extend from the rear portion of the vehicle. While the bike carrier 10 is shown with a corresponding folding mechanism 70 and draw bar 72, this may be exemplary and not all-inclusive nor exclusive. Any kind of hitching system, mechanism or other means of attachment to a vehicle may be used without departing from the present teachings. Moreover, it should be appreciated that the features, components, elements and functionalities of the other embodiments may be combined or altered to achieve a desired folding mechanism for the bike carrier without departing from the spirit and scope of the present teachings.

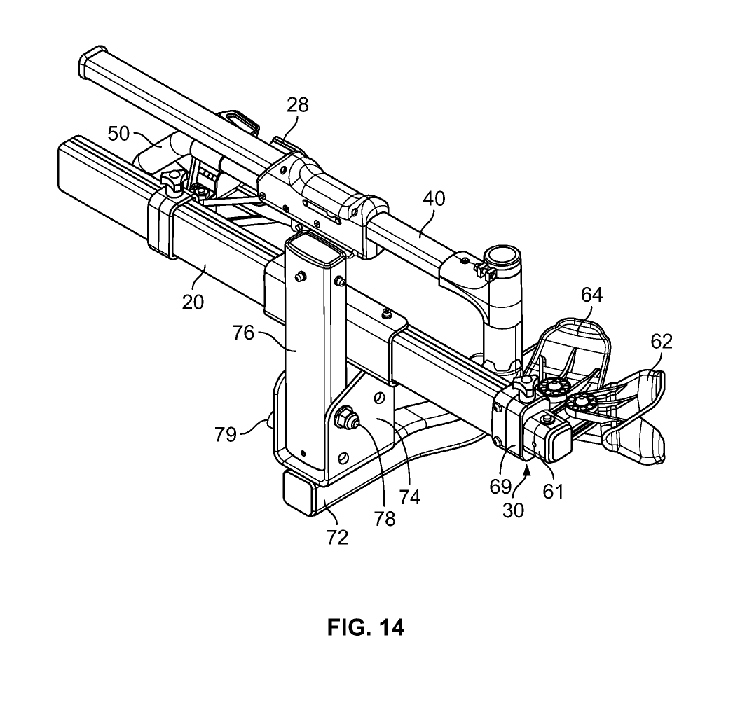

The folding mechanism of the hitch attachment member 70 may permit the bike carrier 10 to be selectively positioned between a first position and a second position. By way of a non-limiting example, the folding mechanism may include the draw arm 72 attached to a hinge member 74 and a support arm 76. The folding mechanism 70 may permit the bike carrier 10 to be selectively rotated or pivoted from a substantially horizontal position to a substantially vertical position relative to the hitch receiver, an example of the bike carrier 10 in the first horizontal position is shown in FIGS. 1-7 and an example of the bike carrier 10 in the second vertical position is shown in FIGS. 14-17.

By way of a non-limiting example, the hitch attachment member 70 may be attached to the longitudinal rail 20, and in particular may be attached to an underside 26 of the longitudinal rail 20 in any appropriate manner—including, without limitation via fasteners, welding, adhering or the like. Still further, it may be monolithically formed with the longitudinal rail 20. In one embodiment, a plate 80 may be attached between the underside 26 of the longitudinal rail 20 and the support arm 76 of the folding mechanism. The position of the longitudinal rail 20 relative to the support arm 76 may allow for a conventional bike to be balanced on the bike carrier 10 relative to the draw bar 72 as it is attached to a hitch receiver of a vehicle. The plate 80 may be shaped to generally conformed to at least a portion of a perimeter of the longitudinal rail 20 and be attached with fasteners 82. The plate 80 may include an aperture 84 located along a portion of the plate 80 that extends from the longitudinal rail 20. The aperture 84 may be of any shape that may allow the user to grasp the bike carrier 10, fold the bike carrier 10 or attach/detach the bike carrier 10 from a vehicle. It may act as a handle. Still further, in some embodiments a gripping member (not shown) may be added to assist in carrying the bike carrier 10.

The hinge member 74 of the folding mechanism may allow the support arm 76 to rotate relative to the draw bar 72 about a pivot point 78. This motion is illustrated by FIG. 7. Additionally, the telescoping rail 30 may be slidingly adjustable relative to the longitudinal rail 20 as illustrated by FIGS. 5 and 6. Here, the telescoping rail 30 is configured to be longitudinally extended or retracted from the longitudinal rail 20. Further, the retaining arm 40 may be adapted to be rotated relative to the longitudinal rail 20 while the hook member 50 may be adapted to be extended or refracted relative to the retaining arm 40 as illustrated by FIG. 6. The hook member 50 may be pivoted and adjusted into a position to support either the frame or the wheel of the bike onto the carrier 10. The adjustable configuration of the bike carrier 10 is configured to accommodate different sizes of wheels and frames of various bikes.

The bike carrier 10 including the longitudinal rail 20, telescoping rail 30, retaining arm 40, hook member 50 and hitch attachment member 70 may be made of any appropriate material, such as for example steel, aluminum, a composite metal or an alloy. Alternatively, the bike carrier 10 may also be made of a combination of other moldable polymer materials such as plastics, fiberglass, and the like.

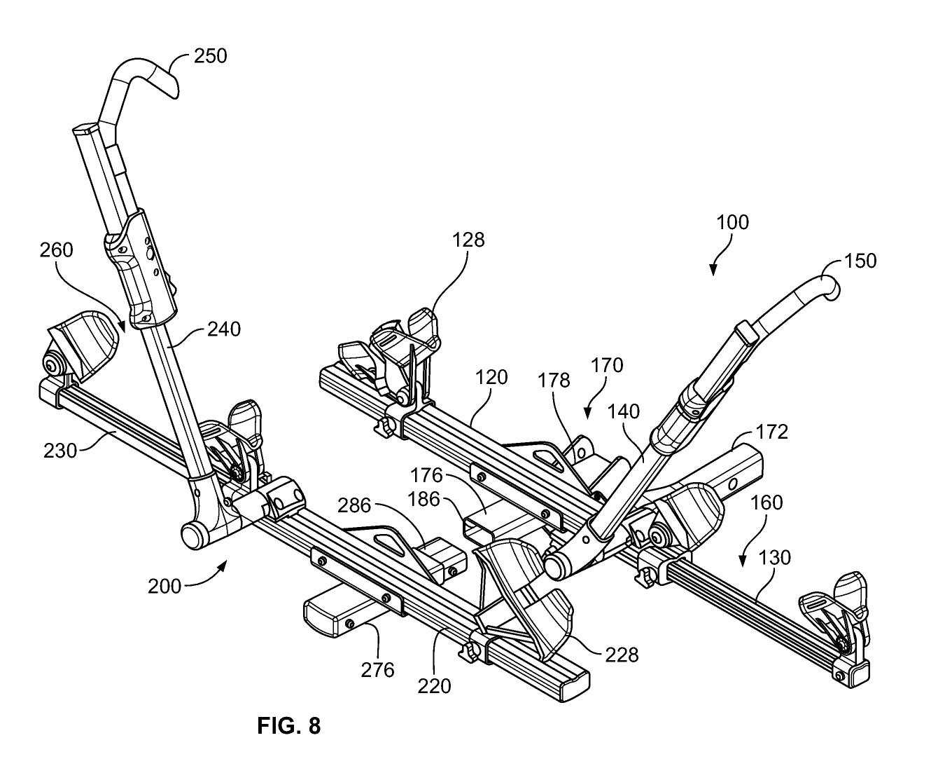

Reference will now be made in detail to the additional embodiments of the disclosure, examples of which are illustrated in the accompanying FIGS. 8-13 Wherever possible, the same or similar reference numbers are used in the these figures and the description to refer to the same or like parts. It should be noted that the drawings are in simplified form and are not to precise scale. Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the disclosure as defined by the appended claims. In the descriptions, all of the details and components may not be fully described or shown. Rather, the main features or components are described and, in some instances, differences with the above-described embodiment may be pointed out. Moreover, it should be appreciated that these additional embodiments may include elements or components utilized in the above-described embodiment although not shown or described. Thus, the descriptions of these additional embodiments are merely exemplary and not all-inclusive nor exclusive.

Turning to FIGS. 8-10, disclosed is a first bike carrier 100 and a second bike carrier 200. The first bike carrier 100 may include similar features to bike carrier 10. The first bike carrier 100 may include a support arm 176 adapted to be selectively attached to a second support arm 276 of the second bike carrier 200. In the illustrated embodiment of FIG. 8-10, the first support arm 176 may have an opening 186 configured to receive an extended portion 286 of the second support arm 276 to be selectively attached thereto. However, the structure of the selective attachment between the first bike carrier 100 and the second bike carrier 200 is not limiting.

Further, the second bike carrier 200 may be directionally opposed to the first bike carrier 100 such that the first bike carrier 100 may be configured to support a front portion of a bike at a first wheel cradle 160 positioned on the right side of FIG. 8 while the second bike carrier 200 may be configured to support a front portion of a bike at a second wheel cradle 260 positioned on the left side of FIG. 8.

Similarly, the first bike carrier 100 and second bike carrier 200 may include longitudinal rails 120, 220 that may be slidingly attached to telescoping rails 130, 230. Wheel support members 128, 228 may be attached to the longitudinal rails 120, 220 to support the rear wheels of the bike, respectively. The telescoping rails 130, 230 may be adapted to extend and retract relative to the longitudinal rails 120, 220, respectively.

Retaining arms 140, 240 may be pivotally arranged relative to the longitudinal rails 120, 220 and may be provided with hook members 150, 250 that may be telescopingly attached to the retaining arms 140, 240. The retaining arms 140, 240 may be arranged to be rotated relative to the longitudinal rails 120, 220. The hook members 150, 250 may be arranged to extend or retract relative to the retaining arms 140, 240, respectively. The hook member 250 may engage the frame of the bike and the hook member 150 may engage a wheel of the bike. Alternatively, the hook members 150, 250 may both engage a frame or both engage a wheel to support the bike on the carrier.

A portion of the longitudinal rails 120, 220 and the telescoping rails 130, 230 may form wheel cradles 160, 260, respectively. Similarly, the telescoping rails 130, 230 may be configured to extend and retract relative to the longitudinal rails 120, 220. This movement adjusts a position of the first and second cradle members 162, 262 and 164, 264 to abut against opposite portions of the front wheel of the loaded bicycle.

The first bike carrier 100 may be attached to a conventional hitch receiver that is attached to a rear portion of a vehicle (not shown). In this embodiment, the first bike carrier 100 may include a hitch attachment member 170. The hitch attachment member 170 may include a folding mechanism with a draw bar 172 that may be capable of selectively attaching to the hitch receiver of the vehicle at the rear portion of the vehicle. The first bike carrier 100 may, therefore, extend from the rear portion of the vehicle while the second bike carrier 200 may extend from the first bike carrier 200. While the bike carriers 100, 200 are shown with a corresponding hitch attachment member 170 and draw bar 172, this may be exemplary and not all-inclusive nor exclusive. Any kind of hitching system, mechanism or other means of attachment to a vehicle may be used without departing from the present teachings. Moreover, it should be appreciated that the features, components, elements and functionalities of the other embodiments may be combined or altered to achieve a desired folding mechanism for the bike carrier without departing from the spirit and scope of the present teachings.

The hitch attachment member 170 may be scalable as it allows for additional bike carriers to be extended therefrom. Additionally, the folding mechanism of the hitch attachment member 170 may permit the first bike carrier 100 and the second bike carrier 200 to be selectively positioned from a first position to a second position. By way of a non-limiting example, the folding mechanism may include the draw arm 172 attached to a hinge member 174 and a support arm 176. The hitch attachment member 170 may permit the first bike carrier 100 and the second bike carrier 200 to be selectively rotated or pivoted from a substantially horizontal position to a substantially vertical position relative to the hitch receiver.

In this embodiment, the hitch attachment member 170 may be attached to the longitudinal rail 120 such that the hinge member 174 of the folding mechanism allows the support arm 176 to rotate relative to the draw bar 172 about a pivot point 178.

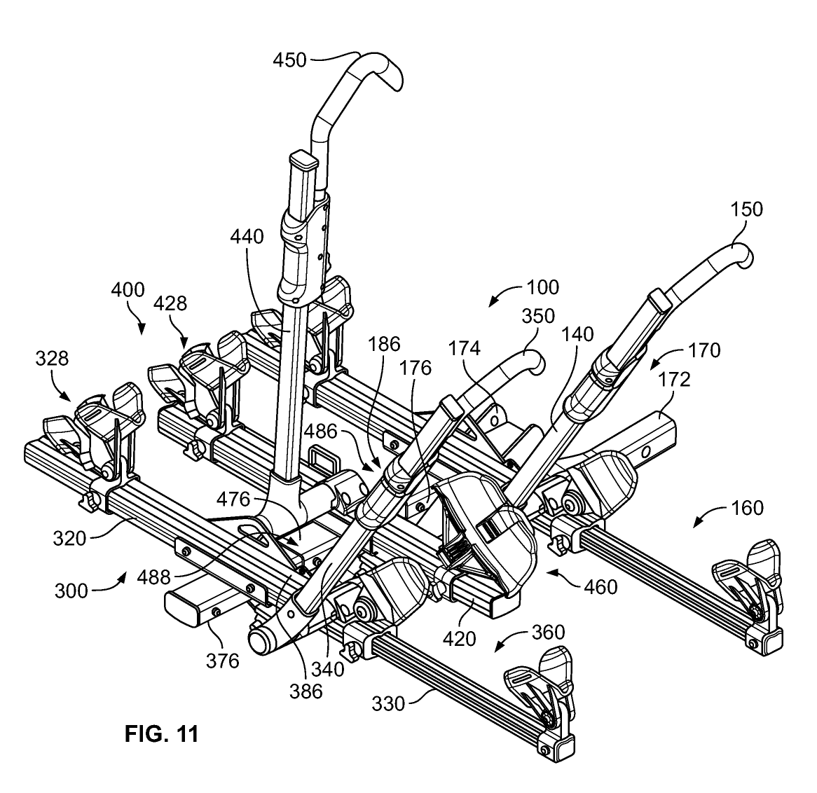

Turning to FIGS. 11-13, disclosed is a third bike carrier 300 that may be selectively attached to the first bike carrier 100 and a middle bike carrier 400. The third bike carrier 300 may include similar features to the first bike carrier 100. The third bike carrier 300 may include a support arm 376 that is adapted to be selectively attached to a middle support arm 476 of the middle bike carrier 400. In the illustrated embodiment of FIGS. 11-13, the first support arm 176 may have opening 186 that is configured to receive an extended portion 486 of the middle support arm 476 to be selectively attached thereto. Similarly, the middle support arm 476 may have an opening 488 that is configured to receive an extended portion 386 of the third support arm 376. However, the structure of the selective attachment between the first bike carrier 100, the middle bike carrier 400 and the third bike carrier 300 is not limiting. Additionally, the scalability of this disclosure is not limiting as a forth, fifth, sixth or more bike carriers may be selectively attached in a scalable manner. Similarly, the middle bike carrier 400 may be attached to the first bike carrier 100 in the same manner. In these embodiments, the middle bike carrier 400 may be selectively removed or attached from the first bike carrier 100. For example, the first bike carrier 100 may be alone in an operative position resulting in the first bike carrier 100 being able to operative hold a single bike or the middle bike carrier 400 may be selectively attached as described above utilizing the opening 186 receiving the extended portion 486 of the middle support arm 476. In this configuration two bikes may be operatively attached.

In these embodiments described above, the third bike carrier 300 may share a common directionality with the first bike carrier 100. However, this arrangement is not limiting as the first, middle, and third bike carriers may all have a common or opposing directionality as described herein.

The third bike carrier 300 may include a longitudinal rail 320 slidingly attached to a telescoping rail 330. A wheel support member 328 may be attached to the longitudinal rail 320 to support the wheel of the bike. The telescoping rail 330 may be adapted to extend and retract relative to the longitudinal rail 320.

Retaining arm 340 may be pivotally arranged relative to the longitudinal rail 320 and provided with hook member 350 that may be telescopingly attached to the retaining arm 340. The retaining arm 340 may be arranged to be rotated relative to the longitudinal rail 320. The hook member 350 may be arranged to extend or retract relative to the retaining arm 340. The hook member 350 may be pivoted and adjusted into a position to support either the frame or the wheel of the bike onto the carrier 300.

A portion of the longitudinal rail 320 and the telescoping rail 330 may form a third wheel cradle 360. Similarly, the telescoping rail 330 may be configured to extend and retract relative to the longitudinal rail 320. This movement may adjust a position of the first and second cradle members 362, 364 to abut against opposite portions of the front wheel of the loaded bicycle. The hook member 350, similar to hook member 150, may be configured to support a wheel of the bike that is positioned within the third wheel cradle 360 and a first wheel cradle 360, respectively. The hook member 350 may be pivoted and adjusted into a position to support either the frame or the wheel of the bike onto the carrier 300.

The middle bike carrier 400 may include a longitudinal rail 420 that may be attached to a first wheel support member 428 and a second wheel support member 460 to support the front and rear wheels of the bike. The first wheel support member 428 and second wheel support member 460 may be longitudinally adjustable and rotationally adjustable relative to the longitudinal rail 420. These support members 428, 460 may include a generally U-shaped cross sectional configuration adapted to receive the wheels of the bike.

In this embodiment, a middle retaining arm 440 may be pivotally arranged relative to the longitudinal rail 420 and provided with hook member 450 that may be telescopingly attached to the middle retaining arm 440. The retaining arm 440 may be arranged to be rotated relative to the longitudinal rail 420. The hook member 450 may be arranged to extend or retract relative to the retaining arm 440. The middle hook member 450 may be configured to support a frame portion of the bike that is positioned between the first wheel support member 428 and the second wheel support member 460 along the longitudinal rail 420. In one embodiment, the middle retaining arm 440 may pivot between the first wheel support member 428 and the second wheel support member 460 relative to the longitudinal rail 420 to ensure that the user utilizes the middle retaining arm 440 to support a frame portion of the loaded bike.

The first bike carrier 100 may be attached to a conventional hitch receiver attached to a rear portion of a vehicle (not shown). In this embodiment, the first bike carrier 100 may include the folding mechanism 170 with a draw bar 172 capable of selectively attaching to the hitch receiver of the vehicle at the rear portion of the vehicle. The first bike carrier 100 may, therefore, extend from the rear portion of the vehicle while the middle bike carrier 400 may extend from the first bike carrier 100 and the third bike carrier 300 may extend from the middle bike carrier 400. While the bike carriers 100, 300, 400 are shown with a corresponding folding mechanism 170 and draw bar 172, this may be exemplary and not all-inclusive nor exclusive. Any kind of hitching system, mechanism or other means of attachment to a vehicle may be used without departing from the present teachings. Moreover, it should be appreciated that the features, components, elements and functionalities of the other embodiments may be combined or altered to achieve a desired folding mechanism for the bike carrier without departing from the spirit and scope of the present teachings.

The folding mechanism 170 may permit the first bike carrier 100, the middle bike carrier 400 and the third bike carrier 300 to be selectively positioned from a first position to a second position. By way of a non-limiting example, the folding mechanism 170 includes the draw arm 172 attached to the hinge member 174 and the support arm 176. The folding mechanism 170 may permit the first bike carrier 100, middle bike carrier 400 and the third bike carrier 300 to be selectively rotated or pivoted from a substantially horizontal position to a substantially vertical position relative to the hitch receiver.

As illustrated by FIGS. 14-17, the bike carrier 10 may be configured in the second or storage position. In this embodiment, by way of a non-limiting example, the support arm 76 of the folding mechanism 70 is pivoted into a generally vertical position as it is pivoted about the pivot point 78 of the hinge member 74. The retaining arm 40 may be pivoted into a position that is generally aligned with the longitudinal rail 20 and the hook member 50 may be retracted to a storage position along the retaining arm 40. Additionally, the telescoping rail 20 may be retracted within the longitudinal rail 30. Additionally, the wheel supporting member 28 may be rotated relative to the longitudinal rail 20 to allow the hook member 50 to be positioned adjacent thereto. Further, the first and second cradle members 62, 64 may be rotated relative to the first and second brackets 61, 69, respectively such that the first bracket 61 abuts against the second bracket 69 in a compact storage arrangement. Additionally, there may be a pin 79 that may selectively lock the support arm 76 in the first or second position within the hinge member 74.

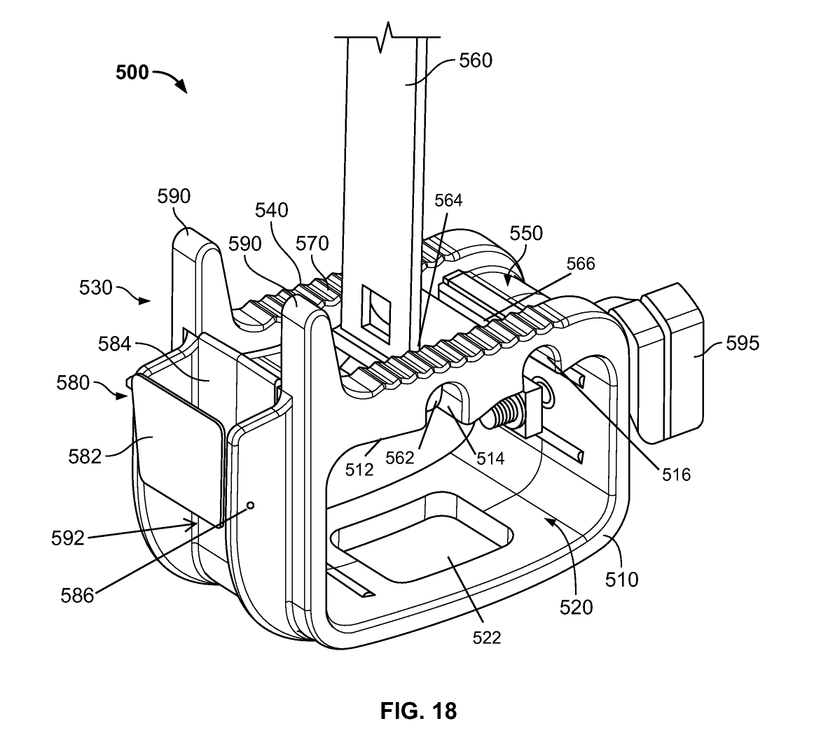

FIGS. 18-20 illustrate an attachment member 500 that is configured to be attached to the stationary or telescoping rails of any embodiment of the disclosed bike carriers 10, 100, 200, 300, 400. The attachment member 500 will be particularly described with reference to the bike carrier 10. The attachment member 500 may include a body portion 510 that defines a cavity 520. The body portion 510 may be a continuous member that defines the cavity 520 or may be separate pieces attached to one another. The cavity 520 may be configured to be received along the telescoping rail 30 of the bike carrier 10 and may be selectively positionable thereon. The body portion 510 may generally surround a perimeter of the telescoping rail 30 such that the attachment member 500 may be slidably adjustable along the rail 30. Additionally, the cavity 520 may be configured to be received along the longitudinal rail 20 as it may be alternatively used to attach either wheel 14, 16 to the bike carrier 10. More that one attachment member 500 may be positioned along the rails 20, 30 of the bike carrier 10. Additionally, the attachment member 500 may be rigidly attached to the rails 20, 30. In one embodiment, the attachment member 500 is attached to the distal end 32 of the telescoping rail 30 wherein at least the first cradle member 62 is removed from the telescoping rail 30. Optionally, the first cradle member 62 or the second cradle member 64 may remain on the bike carrier 10 in addition to the attachment member 500.

Particularly, the attachment member 500 includes a top portion 530 having a surface 540 that defines a groove 550. A strap 560 may be attached to the attachment member 500 and extend therefrom. The strap 560 may include a termination end 562 and may extend through a slot 564 positioned along the top portion 530 such that the strap 560 extends through the surface 540. The slot 564 may be within the groove 550 along the surface 540. Additionally, a second slot 566 may exist along the top portion 530 of the attachment member 500 wherein the strap 560 may optionally extend through either the slot 564 or second slot 566.

The strap 560 may be configured to wrap around a portion of the bike wheel 16 and selectively attach and tighten the wheel to the body 510 of the attachment member 500. The surface 540 may include a plurality of teeth or ridges 570 to provide a frictional engagement with the wheel 16. The teeth 570 may be positioned along either side of the groove 550 and extend from the top portion 530 such that a portion of the strap 560 may be positioned within the groove 550 while the wheel is positioned along the teeth 570. In one embodiment, the teeth 570 may extend from the top portion 530 of the attachment member 500 a dimension that is greater than or equal to the thickness of the strap 560 to allow a portion adjacent the termination end 562 of the strap 560 to be within the groove 550 and under a portion of the wheel 16.

The termination end 562 may be a generally rigid body that is configured to abut against a cavity surface 512. The cavity surface 512 may include a depression 514 that is in alignment with the slot 564 to retain the strap 560 in place. Similarly, a second depression 516 may be positioned along the cavity surface 512 and aligned with the second slot 566 to optionally retain the strap 560 in place. The body 510 of the attachment member 500 may include an aperture 522 to allow the strap 560 to be received therein such that the termination end 562 may be positioned against the cavity surface 512 and retained thereon.

A portion of the strap 560, opposite from the termination end 562 may be received within a locking member 580 to selectively lock the strap 500 in place relative to the body 510. The locking member 580 may include a lock arm 582 that is configured to be selectively opened to receive the strap 560 within a receiving groove 584 and be selectively closed to lock the strap 560 in place as desired. The lock arm 582 may pivot about a pivot hinge 586 and include a biasing member 592 such that the lock arm 582 may be spring loaded.

The attachment member 500 may include a plurality of alignment pegs 590 that extend from the top portion 530 of the body 510. The pegs 590 may extend upwardly from the top portion 530 and be positioned on either side of the groove 550 between the slot 564 and the locking member 580. The pegs 590 may be generally aligned along the top surface 540 and be positioned along an opposite side of the wheel 16 than the strap 560 as it extends through the slots 564, 566. The strap 560 may be configured to fit between the pegs 590 as the strap 560 is wrapped around the wheel 16 while the wheel is positioned along the surface 540 of the top portion 530 of the attachment member 500. As the strap 560 is tightened around the wheel 16, the wheel may be pressed against the pegs 590 to vertically stabilize the wheel 16 along the attachment member 500. The strap 560 may extend through the slot 564 while the strap 560 pulls the wheel towards the pegs 590 with greater force than when the strap 560 extends from the second slot 566.

Additionally, the attachment member 500 may be longitudinally adjustable relative to the longitudinal rail 20 or the telescoping rail 30. In some embodiments, the attachment member 500 may include a fastener 595. The attachment member 500 may be configured to slide along the longitudinal rail 20 or the telescoping rail 30 and the fastener 595 may be ergonomically configured for a user to manually tighten or loosen the fastener 595 to position the attachment member 500 thereon. The fastener 595 may be any type of fastening device that is known in the art and this disclosure is not limited. The fastener 595 may be a screw and nut configuration wherein the nut may be received within a contour of the telescoping rail such that once the fastener 595 is rotated that nut may bring the surface of the rail in close frictional abutment with the cavity surface 512 along the cavity 520 of the body 510 or may create space between the surface of the rail and the cavity surface 512 along the cavity 520 of the body 510.

In one embodiment, the position of the attachment member 500 may be longitudinally adjustable by extending and retracting the telescoping rail 30 relative to longitudinal rail 20. This movement may adjust a position of attachment member 500 to abut against a bottom portion of the wheel 16 of the loaded bicycle 12. In one embodiment, the second cradle member 64 may be attached to the second end 24 of the longitudinal rail 20 and the fastener 66 may be configured to toggle the adjusted position of the telescoping rail 30. Optionally, the second cradle member 64 may be fixed relative to the longitudinal rail 20 or it may be removed.

Although the present embodiments have been illustrated in the accompanying drawings and described in the foregoing detailed description, it is to be understood that the bike carrier is not to be limited to just the embodiments disclosed, but that the bike carrier described herein is capable of numerous rearrangements, modifications and substitutions. The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A bike carrier configured to be attached to a vehicle comprising:
a first rail having a first wheel supporting member positioned at a first end;
a second rail, the first and second rails telescopingly engaged, the second rail having a second wheel supporting member positioned at a second end; and
a hitch attachment member wherein the first rail and second rail are configured to support a bike.

2. The bike carrier of claim 1, wherein the hitch attachment member is configured to be scalable and support at least one additional rail member such that the additional rail member may extend from the hitch attachment member and be configured to support a second bike.

3. The bike carrier of claim 1 further comprising a retaining arm pivotally arranged relative to the longitudinal rail section and includes a hook member that is telescopingly attached to the retaining arm.

4. The bike carrier of claim 3, wherein the retaining arm is configured to pivot between a support position and release position and the hook member is configured to be extended or retracted into a position abutted against the bike when the bike is supported by the bike carrier.

5. The bike carrier of claim 1, wherein the second wheel supporting member includes a wheel cradle having a first cradle member attached to the telescoping rail and a second cradle member attached to the longitudinal rail.

6. The bike carrier of claim 5, wherein the first cradle member includes a generally U-shaped cross section and is configured to receive a portion of the wheel of the bike and the second cradle member has a generally U-shaped cross section and is configured to receive a portion of the wheel of the bike.

7. The bike carrier of claim 5, wherein the first cradle member is longitudinally adjustable relative to the second cradle member by extending and retracting the telescoping rail relative to longitudinal rail.

8. The bike carrier of claim 1, wherein the hitch attachment member includes a folding mechanism, the folding mechanism includes a draw bar configured to be selectively attached to the hitch receiver and secured to the vehicle wherein the folding mechanism is configured to tilt the bike carrier from an in-use position to a storage position.

9. The bike carrier of claim 8, wherein the folding mechanism includes a support arm that is configured to support additional rail members in a generally scalable arrangement such that a plurality of rail members can extend from the hitch attachment member and tilt from the in-use position into the storage position.

10. The bike carrier of claim 1, wherein the second rail member includes a support arm configured to be attached to the hitch attachment member.

11. The bike carrier of claim 10, wherein a third rail member includes a support arm configured to be attached to the support arm of the second rail member.

12. The bike carrier of claim 1, wherein at least one of the first wheel supporting member and the second wheel supporting member is an attachment member that includes a strap configured to selectively attach and tighten the wheel to the attachment member.

13. The bike carrier of claim 12, wherein the attachment member includes a body portion that defines a cavity configured to be received along the telescoping rail, the attachment member includes a top portion having a surface for supporting a wheel of the bike, the surface defines a groove and includes a slot such that the strap extends through the slot and is configured to be positioned within the groove along the surface as the wheel is positioned on the surface.

14. The bike carrier of claim 13, wherein the attachment member includes a second slot.

15. The bike carrier of claim 13, wherein the surface of the attachment member includes a plurality of teeth to provide a frictional engagement with the wheel of the bike.

16. The bike carrier of claim 12, wherein the attachment member includes at least one alignment peg that extends from the body, the peg configured to vertically stabilize the wheel along the attachment member.

17. A scalable bike carrier system configured to be attached to a vehicle comprising:
a first bike carrier including a hitch attachment member configured to attach the first bike carrier to the vehicle; and
a second bike carrier include a support member, the support member configured to be selectively attached to the first bike carrier.

18. The scalable bike carrier system of claim 17 further comprising a third bike carrier that includes a support member, the support member configured to be selectively attached to the second bike carrier.

19. The scalable bike carrier system of claim 17, wherein the first bike carrier further includes a longitudinal rail with a first wheel supporting member positioned near a first end; and
a telescoping rail configured to be extended and retracted relative to the longitudinal rail, the telescoping rail including a second wheel supporting member positioned at an opposite second.

20. The scalable bike carrier system of claim 17, wherein the support member of the second bike carrier is configured to selectively attach to the hitch attachment member, the hitch attachment member including a folding mechanism configured to pivot from the in-use position into the storage position.

21. The scalable bike carrier system of claim 17, further comprising a retaining arm pivotally attached to the first bike carrier and a retaining arm pivotally attached to the second bike carrier.

22. The bike carrier of claim 21, wherein the retaining arm of the first bike carrier includes a hook wherein the retaining arm and hook are configured to be adjusted to directly support either a bike frame or a bike wheel on the first bike carrier.

23. The bike carrier of claim 22, wherein the retaining arm of the second bike carrier includes a hook wherein the retaining arm and hook are configured to be adjusted to directly support either a bike frame or a bike wheel on the second bike carrier.

24. A bike carrier configured to be attached to a vehicle comprising:
a first rail having a first wheel supporting member positioned at a first end;
a second rail, the first and second rails telescopingly engaged, the second rail having a second wheel supporting member positioned at a second end;
a hitch attachment member; and
wherein at least one of the first wheel supporting member and the second wheel supporting member is an attachment member that includes a strap configured to selectively attach and tighten the wheel to the attachment member.

25. The bike carrier of claim 24, wherein the attachment member includes a body portion that defines a cavity configured to be received along the telescoping rail, the attachment member includes a top portion having a surface for supporting a wheel of the bike, the surface defines a groove and includes a slot such that the strap extends through the slot and is configured to be positioned within the groove along the surface as the wheel is positioned on the surface.

26. The bike carrier of claim 25, wherein the attachment member includes a second slot.

27. The bike carrier of claim 25, wherein the surface of the attachment member includes a plurality of teeth to provide a frictional engagement with the wheel of the bike.

28. The bike carrier of claim 24, wherein the attachment member includes at least one alignment peg that extends from the body, the peg configured to vertically stabilize the wheel along the attachment member.
